(19) United States
(12) Patent Application Publication
(10) Pub. No.: US 2012/0089765 A1
(43) Pub. Date: Apr. 12, 2012

(54) METHOD FOR PERFORMING AUTOMATIC BOUNDARY ALIGNMENT AND RELATED NON-VOLATILE MEMORY DEVICE

(76) Inventors: Shih-Chia Huang, Taipei City (TW); Yung-Tai Yang, Taipei County (TW); Li-Jen Chao, Taipei County (TW); Chih-Heng Chiu, Taipei City (TW); Chung-Won Shu, Taipei City (TW)

(21) Appl. No.: 12/899,555

(22) Filed: Oct. 7, 2010

(51) Int. Cl. G06F 12/02; G06F 12/00

(52) U.S. Cl. 711/103; 711/201; 711/171; 711/E12.001; 711/E12.002; 711/E12.008

(57) ABSTRACT

A non-volatile memory device is configured to perform automatic boundary alignment between logical access units of a file system and physical access units of the non-volatile memory device. The file system of the non-volatile memory device is configured to include a partition having a system data area and a user data area which comprises a plurality of logical access units. The boundaries of the logical access units in the partition are aligned with the boundaries of physical access units of the non-volatile memory device. Unnecessary data access may be reduced without introducing an additional mapping table or re-formatting storage space in the partition.

### BACKGROUND OF THE INVENTION

1. Field of the Invention

The present invention is related to a method for performing automatic boundary alignment and related device, and more particularly, to a method for performing automatic boundary alignment between logical access units and physical access units in a non-volatile memory device and related non-volatile memory device.

2. Description of the Prior Art

Flash memories are a special type of a non-volatile memory capable of electrically erasing and programming data. Compared to traditional magnetic disc memory based devices, flash memory based storage devices are characterized in low power consumption, small size and high data storage density.

In flash memories, memory cells need to be returned to an original state in which data can be over-written after a previous write operation. This operation is called “erase” and typically requires much more time than a write operation. Memory cells of a typical flash memory device are accessed in physical address and divided into discrete blocks each of which includes a number of pages. The block is the basic physical unit for erasing data on the flash memory device. Each block typically comprises a number of pages, which are the basic physical units for programming and reading data.

A host system often executes a file data management according to file allocation table (hereinafter referred to as FAT) file system, a common file management system in which a cluster is used as a basic logical access unit.

Since the host system with FAT file system typically uses cluster as the basic logical access unit while the flash memory based storage device typically uses page as basic physical access unit, there maybe difference in size of page and cluster. If the host system is not aware of the actual size of each page in the flash memory based storage device, the boundaries of the clusters arranged by the host system for storing user data may not be aligned with the boundaries of the pages. In such event, a cluster may extend from a first page to a second page, thereby causing unnecessary data access. In the worst scenario, a request to write (overwrite) a page of data may require one erase operation of all sectors in two blocks and several write operations to recover the portions of the erased blocks which are not requested to be written but unavoidably erased due to inconsistent and misaligned units based on which the write and erase commands are executed.

One possible solution to this problem is to format the flash memory so that the cluster boundaries are aligned with the page boundaries. However, boundary alignment can only be achieved when the host system is aware of the page size and block size of the flash memory before the formatting process. However, this could rarely be achieved because there are numerous kinds of flash memory based storage devices with different page sizes and block sizes. This technique is also disadvantageous in its disability to retain previously stored user data.

Another possible solution to this problem is to implement an offset in a physical-to-logical mapping table so that the physical address for accessing pages is changed by a constant value in order to align cluster boundaries with page boundaries. The value of the offset is calculated based on characteristics of the file system and the page size and block size of a certain flash memory and stored in the controller. If the host system is reconfigured (such as altering cluster size, rearranging the number and/or the size of partitions, or formatted to another file system) for some reasons, the previously acquired offset value is no longer valid and a misalignment between the cluster boundaries and the page boundaries may occur.

Therefore, there is a need for an improved method of relocating data in the file system for aligning the boundaries of logical access units (such as clusters) with the boundaries of physical access units (such as pages) of a memory device in order to improve data accessing efficiency while retaining the integrity of host data.

### SUMMARY OF THE INVENTION

The present invention provides a method for performing automatic boundary alignment between logical access units and physical access units in a non-volatile memory device. The method includes configuring a file system of the non-volatile memory device to include a partition having a system data area and a user data area which comprises a plurality of logical access units, wherein a boundary of the partition is aligned with a boundary of physical access units of the non-volatile memory device; detecting whether a misalignment occurs between the boundaries of logical access units in the user data area and boundaries of physical access units of the non-volatile memory device; and relocating data in the system data area and the user data area so that the boundaries of logical clusters in the user data area is aligned with boundaries of physical pages of the non-volatile memory device after detecting the misalignment.

The present invention also provides a non-volatile memory device with automatic boundary alignment between logical access units and physical access units. The non-volatile memory device includes a memory unit having a file system configured to include a partition having a system data area and a user data area which comprises a plurality of logical access units, wherein a boundary of the partition is aligned with a boundary of physical access units of the non-volatile memory device; and a controller configured to detect a misalignment between the boundaries of the logical access units in the user data area and boundaries of physical access units of the non-volatile memory device, and configured to relocate data in the system data area and the user data area so as to align the boundaries of logical clusters in the user data area with boundaries of physical access units of the non-volatile memory device after detecting the misalignment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a non-volatile memory device according to the present invention.

FIG. 2 is a diagram illustrating a file system according to an embodiment of the present invention.

FIGS. 3A-3C and 4A-4C are diagrams illustrating the detailed configurations of a partition according to the present invention.

FIG. 5 is a flowchart illustrating a method of performing automatic boundary alignment between logical clusters and physical pages in a non-volatile memory device according to an embodiment of the present invention.

### DETAILED DESCRIPTION

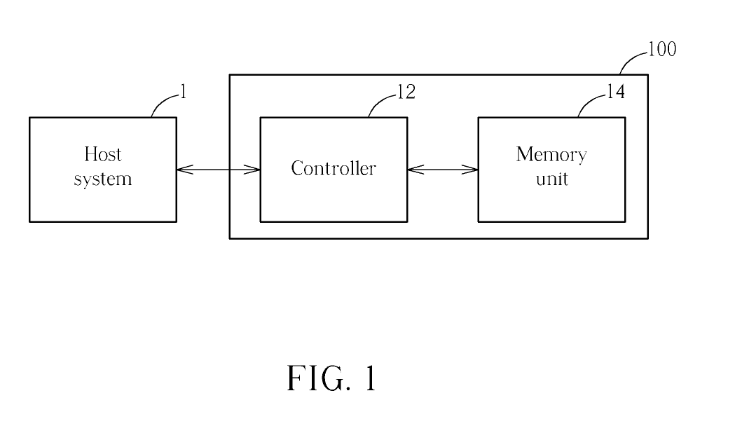

FIG. 1 is a block diagram of a non-volatile memory device 100 according to the present invention. The non-volatile memory device 100 includes a controller 12 and a memory unit 14. The controller 12, usually (but not necessarily) allocated on a separate integrated circuit chip, is configured to function as an interface of the host system 1 to which the non-volatile memory device 100 maybe connected in a removable manner, thereby controlling operations of the memory cells within the memory unit 14 upon receiving a command from the host system 1. The controller 12 may include a microprocessor, a non-volatile read-only-memory (ROM), a volatile random-access-memory (RAM) and one or more special circuits such as one capable of calculating an error-correction-code (ECC). The memory unit 14 may be a flash memory including NAND flash memory, NOR flash memory, and may also include memory cards constituted by such flash memory, including but not limited to compact flash (CF) cards, multi media cards (MMCs), secure digital (SD) cards, personnel tags (P-Tags), or memory stick (MS) cards. The host system 1 may include personal computers, notebook computers, personal digital assistants (PDAs), various data communication devices, digital cameras, cellular telephones, portable audio players, automobile sound systems, and similar types of equipment.

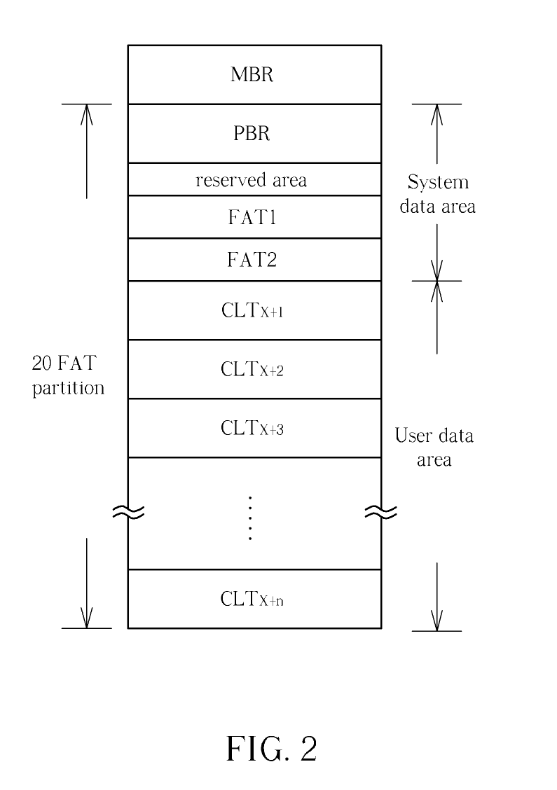

FIG. 2 is a diagram illustrating a file system based on which data management is performed on the non-volatile memory device 100 according to an embodiment of the present invention. Being a computer file system architecture widely used on many computer systems and storage devices, the FAT file system is shown in FIG. 2 for illustrative purpose. The FAT file system typically includes a master boot record MBR and a FAT partition 20. The MBR is configured to hold the primary partition table of the FAT file system (size, number, location and type of partitions) for booting the non-volatile memory device 100. The FAT partition 20, a logical address range for placing the FAT file system, includes a system data area and a user data area which comprises a plurality logical access units (referred to as “clusters” in the FAT file system). The system data area may be configured to include a partition boot recording PBR, two file allocation tables FAT1 and FAT2, and a reserved area. The partition boot recording PBR is located in a head logical address of the FAT partition 20 and is configured to store some basic file system information, in particular its type, and pointers to the location of the other sections. The FAT1 and FAT2 contain copies of the file allocation tables for the sake of data backup and indicating a usage state of the user data area. The user data area is where the actual user data files are stored and takes up most of the FAT partition 20. The logical access units in the user data area includes are a plurality of equally-sized clusters CLTₓ-CLTₓ₊ₙ. After allocating the partition boot recording PBR, the two file allocation tables FAT1 and FAT2, and the reserved area, the remaining space in the FAT partition 20 constituting the unused area 26 is smaller than the size of each cluster in the user data area.

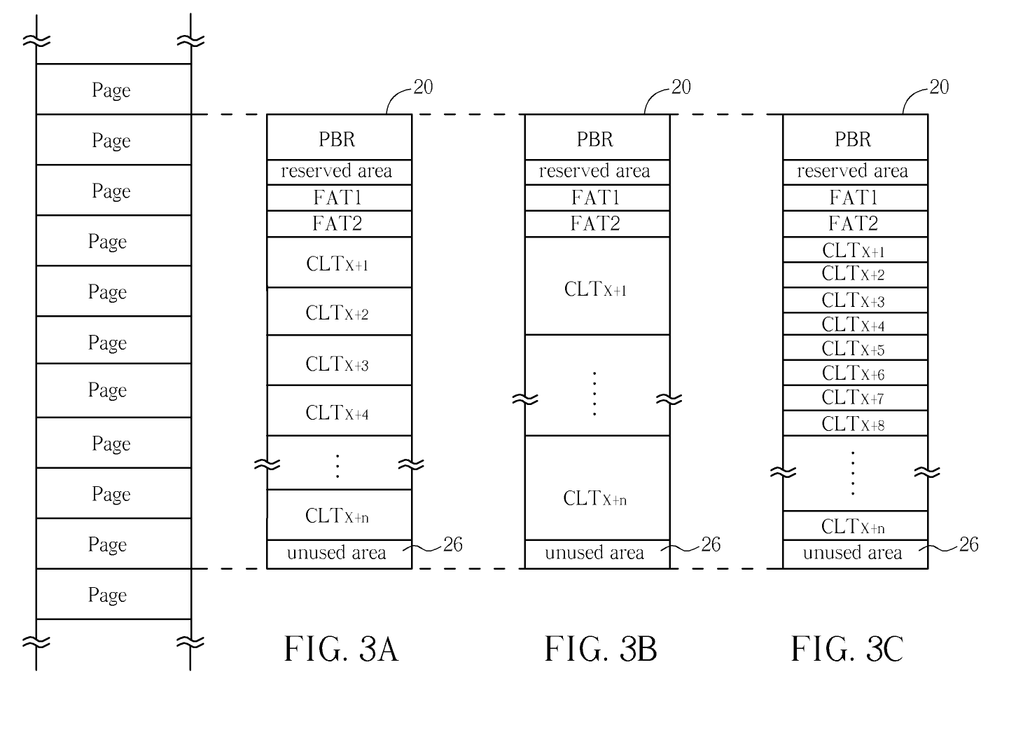

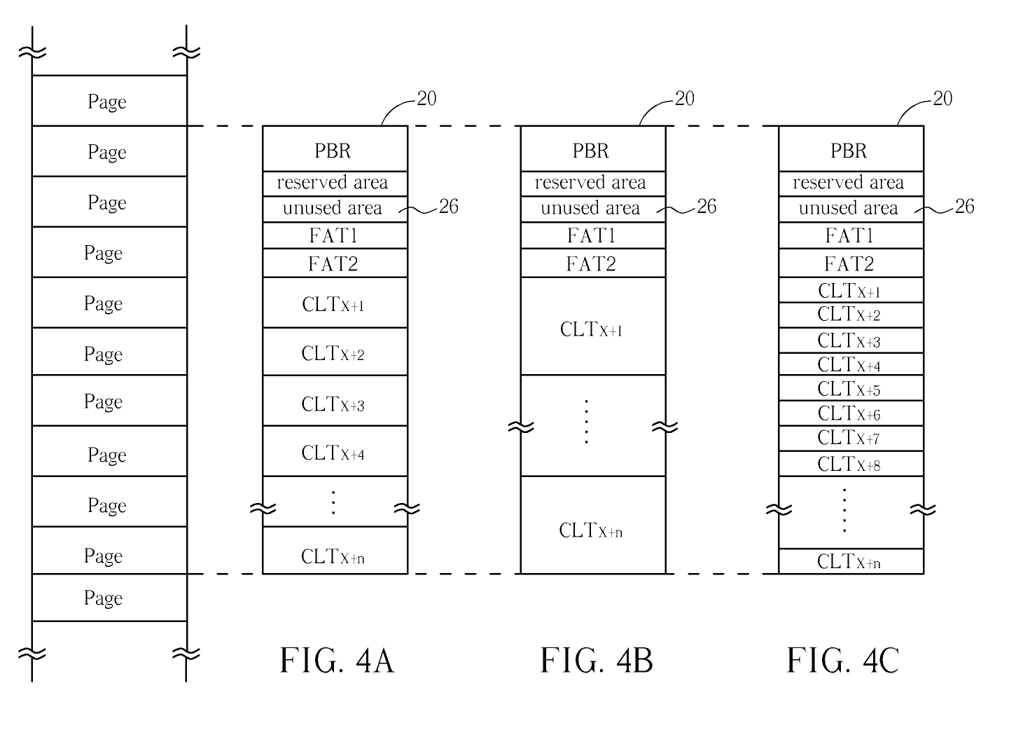

FIGS. 3A-3C and 4A-4C are diagrams illustrating the detailed configurations of the FAT partition 20 before and after boundary alignment according to an embodiment the present invention. The sizes of the basic logical access unit of data (such as cluster) and the basic physical access unit (such as page) in the memory unit 14 may vary in different configurations. In the embodiments illustrated in FIGS. 3A and 4A, each page and each cluster are of the same size; in the embodiments illustrated in FIGS. 3B and 4B, each cluster is twice the size of each page; in the embodiment illustrated in FIGS. 3C and 4C, each page is twice the size of each cluster.

FIGS. 3A-3C are diagrams illustrating the detailed configurations of the FAT partition 20 before boundary alignment. Since the page size and cluster size are known factors when manufacturing the non-volatile memory device 100, the configuration of the memory unit 14 may be initialized so that the boundary of the FAT partition 20 is aligned with the boundary of the physical pages of the non-volatile memory device 100, as indicated by the dotted lines in FIG. 3A-3C. Although the boundary of the FAT partition 20 is aligned with the boundary of pages at manufacture stage, a boundary misalignment between cluster and page may still occur for some reason (such as after a user re-formats the memory device 100 by an operating system which is not aware of the actual size of the page and block), which will result in an unused area 26, a residue in the user data area that is unable to be further allocated to another cluster, to exist at the end of the FAT partition 20, as depicted in FIGS. 3A-3C.

FIGS. 4A-4C are diagrams illustrating the detailed configurations of the FAT partition 20 after boundary alignment according to an embodiment of the present invention. As shown in FIGS. 4A-4C, data stored in the original clusters CLTₓ-CLTₓ₊ₙ, FAT1 and FAT2 may be relocated so as to assure that the boundaries of the relocated clusters CLTₓ-CLTₓ₊ₙ are aligned with the boundaries of corresponding pages. The alignment between logical clusters and physical pages guarantees minimum amount of page access and can improve data efficiency. Unlike the formatting sequence, the present invention is able to achieve cluster/page alignment while retaining the stored data.

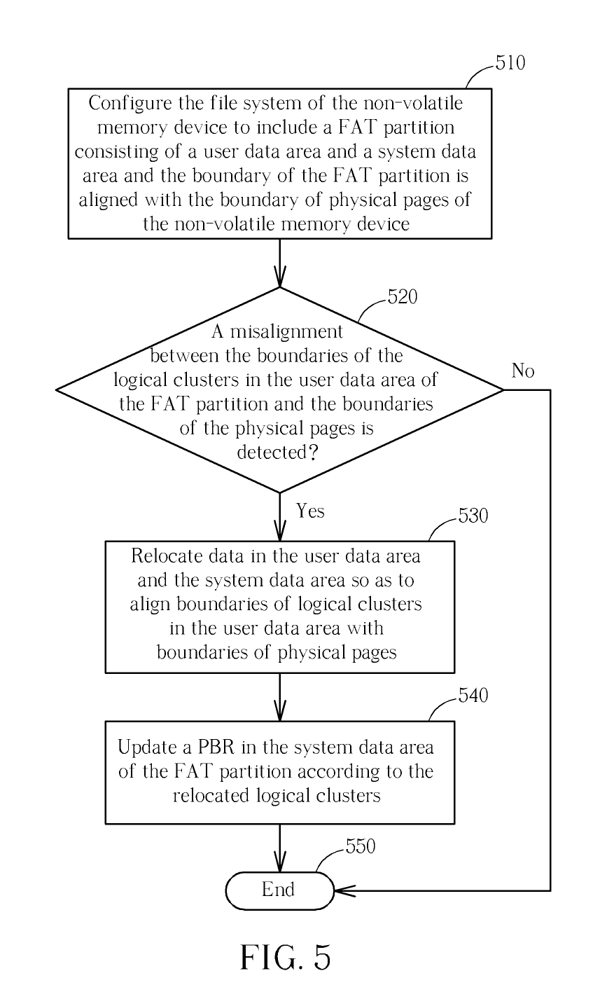

FIG. 5 is a flowchart illustrating a method of performing automatic boundary alignment between logical clusters and physical pages in a non-volatile memory device according to an embodiment of the present invention. FIG. 5 includes the following steps:

Step 510: During manufacture, configure the file system of the non-volatile memory device to include a FAT partition consisting of a user data area and a system data area and the boundary of the FAT partition is aligned with the boundary of physical pages of the non-volatile memory device.

Step 520: detect whether a misalignment between the boundaries of logical clusters in the user data area and the boundaries of physical pages of the non-volatile memory device is present; if a misalignment is detected, execute step 530; if no misalignment is detected, execute step 550.

Step 530: Relocate data in the user data area and the system data area so as to align boundaries of logical clusters in the user data area with boundaries of physical pages of the non-volatile memory device.

Step 540: Update a PBR in the system data area of the FAT partition according to the relocated logical clusters.

Step 550: End.

Step 510 is executed when manufacturing the non-volatile memory device 100.

In step 520, the controller 12 in FIG. 1 is configured to detect the presence of boundaries misalignment between logical clusters in the user data area and corresponding pages of the non-volatile memory device. Step 520 may be executed by comparing logical addresses of the clusters in the user data area to physical addresses of pages. Step 520 may be executed during a booting sequence of the non-volatile memory device or anytime when the controller 12 takes over the control of the non-volatile memory device. The detection of boundary misalignment takes negligible amount of time and does not influence the overall booting sequence.

By aligning the boundary of the FAT partition 20 with the boundary of corresponding pages, if a boundary misalignment between logical clusters and physical pages is detected in step 520, the unused area 26, a residue in the user data area that is unable to be further allocated to another cluster, will in result exist at the end of the FAT partition 20, as depicted in FIGS. 3A-3C, and step 530 is then executed to restore boundary alignment. FAT1, FAT2, the clusters CLTₓ-CLTₓ₊ₙ of the FAT partition 20, as well as data stored therein, may be relocated. Therefore, the starting addresses and ending addresses of the clusters CLTₓ-CLTₓ₊ₙ may be relocated so as to align with the corresponding page boundaries. Step 530 may be executed during the booting sequence of the non-volatile memory device 100 or when the non-volatile memory device 100 is in an idle state.

In the above descriptions, though the FAT file system was described as the exemplary file system according to an embodiment of the present invention, other file system used for storing and organizing computer files and data, such as NTFS, HFS, UFS, ZFS, ext*, etc., provided that such file system includes user data area composes of a plurality of logical access units, may be applied to the present invention as well.

The memory unit 14 constituting the non-volatile memory device 100 according to the present invention is not limited to a flash memory, but may be any kind of non-volatile memory composed of physical access units, such as MRAM, PROM, EEPROM, FeRAM, PRAM, Hard disk, etc.

In the above descriptions, the non-volatile memory device 100, a flash memory storage device which is formatted into a FAT file system, is used for illustrating the present embodiment. In this embodiment, the logical access unit is cluster and the physical access unit is page. However, the logical and physical access units may have various definitions or be named differently according to the specification of each kind of file system and non-volatile memory. For example, in third extended (ext3) file system commonly used by the Linux kernel, the logical access unit is named “block”. Therefore, the logical access unit of “cluster” of FAT file system and the physical access unit of “page” of flash memory are merely for illustrative purpose and do not limit the scope of the present invention.

As described above, the present invention can reduce the number of access times to the minimum without introducing an additional mapping table or re-formatting storage space in the partition. Data efficiency can largely be improved while able to retain previously stored host data.

Those skilled in the art will readily observe that numerous modifications and alterations of the device and method may be made while retaining the teachings of the invention.

What is claimed is:

1. A method for performing automatic boundary alignment between logical access units and physical access units in a non-volatile memory device, the method comprising:
configuring a file system of the non-volatile memory device to include a partition having a system data area and a user data area which comprises a plurality of logical access units, wherein a boundary of the partition is aligned with a boundary of physical access units of the non-volatile memory device;
detecting whether a misalignment occurs between boundaries of logical access units in the user data area and boundaries of physical access units of the non-volatile memory device; and
relocating data in the system data area and the user data area so that the boundaries of the logical access units in the user data area are aligned with boundaries of physical pages of the non-volatile memory device after detecting the misalignment.

2. The method of claim 1 wherein the file system is a file allocation table (FAT) file system having the system data area further configured to include a partition boot recording (PBR) for storing basic file system information and a first FAT for indicating a usage state of the file area.

3. The method of claim 2 further comprising:
relocating the first FAT after detecting the misalignment; and
updating the PBR according to the relocated data.

4. The method of claim 2 wherein the file system of the non-volatile memory device is configured so that the system data area of the partition further includes a reserved area and a second FAT which is a copy of the first FAT for data backup.

5. The method of claim 4 further comprising:
relocating the first and second FATs after detecting the misalignment; and
updating the PBR according to the relocated data.

6. The method of claim 1 wherein an occurrence of the misalignment is detecting during a booting sequence of the non-volatile memory device.

7. The method of claim 1 wherein relocating the data in the system data area and the user data is performed during a booting sequence or in an idle state of the non-volatile memory device.

8. A non-volatile memory device with automatic boundary alignment between logical access units and physical access units, comprising:
a memory unit having a file system configured to include a partition having a system data area and a user data area which comprises a plurality of logical access units, wherein a boundary of the partition is aligned with a boundary of physical access units of the non-volatile memory device; and
a controller configured to detect a misalignment between the boundaries of logical access units in the user data area and boundaries of physical access units of the non-volatile memory device, and configured to relocate data in the system data area and the user data area so as to align boundaries of logical access units in the user data area with boundaries of physical access units of the non-volatile memory device after detecting the misalignment.

9. The non-volatile memory device of claim 8 wherein the file system is a FAT file system having the system data area further configured to include a PBR for storing basic file system information, a file area for storing user data, and a first FAT for indicating a usage state of the file area.

10. The non-volatile memory device of claim 9 wherein the controller is further configured to relocate the first FAT after detecting the misalignment and update the PBR according to the relocated data.

11. The non-volatile memory device of claim 9 wherein the file system is configured so that the system data area further includes a reserved area and a second FAT which is a copy of the first FAT for data backup.

12. The non-volatile memory device of claim 11 wherein the controller is further configured to relocate the first and second FATs after detecting the misalignment and update the PBR according to the relocated data.

13. The non-volatile memory device of claim 8 wherein the memory unit includes a flash memory.

14. The non-volatile memory device of claim 8 wherein the controller is configured to detect the misalignment during a booting sequence.

15. The non-volatile memory device of claim 14 wherein the controller is configured to relocate the data in the system data area and the user data area after detecting the misalignment during a booting sequence or in an idle state of the non-volatile memory device after detecting the misalignment.
